(19) United States
(12) Patent Application Publication
(10) Pub. No.: US 2022/0191113 A1
(43) Pub. Date: Jun. 16, 2022

(54) METHOD AND APPARATUS FOR MONITORING ABNORMAL IOT DEVICE

(71) Applicant: KOREA INTERNET & SECURITY AGENCY, Jeollanam-do (KR)

(72) Inventors: Sung Taek Oh, Jeollanam-do (KR); Woong Go, Jeollanam-do (KR); Hong Geun Kim, Jeollanam-do (KR); Jae Hyuk Lee, Jeollanam-do (KR)

(73) Assignee: KOREA INTERNET & SECURITY AGENCY, Jeollanam-do (KR)

(21) Appl. No.: 17/208,889

(22) Filed: Mar. 22, 2021

(30) Foreign Application Priority Data
Dec. 16, 2020 (KR) 10-2020-0176184

(51) Int. Cl. H04L 12/26; G06K 9/62; G16Y 30/00

(52) U.S. Cl. CPC H04L 43/062; H04L 43/045; G16Y 30/00; G06K 9/6226; G06K 9/6247

(57) ABSTRACT

Provided is a method performed by a computing device for monitoring an abnormal behavior of a plurality IoT devices. The method comprises determining abnormality of a behavior of each of the plurality of IoT devices based on traffic data representing the behavior of each of the plurality of IoT devices, clustering the behavior of each of the plurality of IoT devices based on the traffic data and a result of the determining the abnormality and generating data for representing a plurality of clusters formed as a result of the clustering such that a first cluster corresponding to a normal behavior cluster and a second cluster corresponding to an abnormal behavior cluster are displayed on different planes, the first cluster and the second cluster being divided based on the result of the determining the abnormality.

This patent application claims the benefit of Korean Patent Application No. 10-2020-0176184, filed on Dec. 16, 2020, which is hereby incorporated by reference in its entirety into this application.

### FIELD

The present disclosure relates to a method and an apparatus for monitoring an abnormal behavior of an IoT device. More specifically, the present disclosure relates to a method and an apparatus for clustering the behavior of each of a plurality of IoT devices based on traffic data representing the behavior of a plurality of IoT devices, and displaying a cluster formed as a result of the clustering.

### DESCRIPTION OF THE RELATED ART

The Internet of Things (IoT) refers to a device operating connected to Internet. These IoT-related technologies are trending toward expanding the scope of application of technologies as Internet technologies develop.

In order for IoT devices to stably function, technologies related to security of IoT devices are indispensable. In prior art related to the security of IoT devices, there is a signature-based detection technology that detects well-known threats to IoT devices, but the signature-based detection technology works smoothly on known threats, and there is a problem with having difficulty in responding to new security threats that change and evolve from time to time.

Further, technologies for detecting an abnormal behavior of traffic data by machine learning algorithms are also being tried. However, these technologies detect an abnormal behavior of individual IoT devices and cannot intuitively monitor an abnormal behavior of a plurality of IoT devices connected to the network.

Therefore, a technology for intuitively monitoring an abnormal behavior of a plurality of IoT devices connected to a network is required.

### SUMMARY

The technical problem to be solved by some embodiments of the present disclosure is to provide a method and an apparatus for intuitively monitoring an abnormal behavior of a plurality of IoT devices connected to a network.

Another technical problem to be solved by some embodiments of the present disclosure is to provide a method and an apparatus for a user to immediately check an abnormal behavior of an IoT device.

Another technical problem to be solved by some embodiments of the present disclosure is to provide a method and an apparatus capable of identifying an abnormal behavior of IoT devices classified into similar types by a cluster.

The technical problems of the present disclosure are not limited to the technical problems mentioned above, and other technical problems that are not mentioned will be clearly understood by those skilled in the art from the following description.

According to a method performed by a computing device for monitoring an abnormal behavior of a plurality of IoT devices comprising determining abnormality of a behavior of each of the plurality of IoT devices based on traffic data representing the behavior of each of the plurality of IoT devices, clustering the behavior of each of the plurality of IoT devices based on the traffic data and a result of the determining the abnormality and generating data for representing a plurality of clusters formed as a result of the clustering such that a first cluster corresponding to a normal behavior cluster and a second cluster corresponding to an abnormal behavior cluster are displayed on different planes, the first cluster and the second cluster being divided based on the result of the determining the abnormality.

According to an embodiment, wherein the clustering comprises, generating a vector corresponding to the behavior of each of the plurality of IoT devices based on the traffic data and the result of the determination of the abnormality, reducing a dimension of the vector to a predetermined dimension and clustering the behavior of each of the plurality of IoT devices based on a dimension-reduced vector.

According to an embodiment the method further comprises, extracting, from the traffic data, an origination country of traffic or a destination county of the traffic.

According to an embodiment the method further comprises, extracting, from the traffic data, a port information related to traffic, the port information including an originating port or a destination port.

According to an embodiment, wherein extracting the port information comprises, based on a type of the port being a well-known port type, designating a port number as the port information, and based on the type of the port being a registered port type or a dynamic port type, designating a predetermined character string as the port information.

According to an embodiment the method further comprises, one-hot encoding an information of a protocol associated with the traffic data.

According to an embodiment, wherein reducing the dimension of the vector to the predetermined dimension comprises, reducing the dimension of the vector to two dimensions using PCA (Principal Components Analysis).

According to an embodiment, wherein clustering the behavior of each of the plurality of IoT devices based on the dimension-reduced vector comprises, clustering the behavior of each of the plurality of IoT devices using DBSCAN (Density-Based Spatial Clustering of Applications with Noise).

According to an embodiment, wherein determining the abnormality of the behavior of each of the plurality of IoT devices based on the traffic data representing the behavior of each of the plurality of IoT devices comprises, generating a score representing the abnormality of the behavior of each of the plurality of IoT devices, wherein generating the data for representing the plurality of clusters comprises, generating the data for displaying the dimension-reduced vector corresponding to the behavior of each of the plurality of IoT devices and the score in a three-dimensional space.

According to an embodiment, wherein generating the data for representing the plurality of clusters comprises, generating the data such that the first cluster is displayed in a space where a z-axis value is positive in the three-dimensional space, and the second cluster is displayed in the space where the z-axis value is negative in the three-dimensional space.

According to an embodiment, wherein generating the data for representing the plurality of clusters comprises, generating an individual indicator representing each of the behavior of each of the plurality of IoT devices included in a target cluster.

According to an embodiment, wherein generating the individual indicator comprises, generating data for highlighting the individual indicator representing the each of the behavior, the highlighting being based on a duration of the each of the behavior.

According to an embodiment, wherein generating the individual indicator comprises, generating a display data for highlighting the individual indicator representing a behavior of IoT devices that has newly identified as falling into the target cluster.

According to an embodiment, wherein generating the data for representing the plurality of clusters comprises, generating the data for highlighting a target cluster based on the number of behaviors of IoT devices that has newly identified as falling into the target cluster per unit time.

According to an embodiment, wherein generating the data for representing the plurality of clusters comprises, in response to recognizing a behavior of a IoT device that has newly identified as falling into the second cluster, generating the data for highlighting the second cluster.

According to an embodiment the method further comprises, regenerating the data for representing the plurality of clusters at each predetermined time interval.

According to an embodiment, wherein regenerating the data for representing the plurality of clusters comprises, gradually representing a process of changing the display data for the plurality of clusters.

According to another aspect of the present disclosure, there is provided an apparatus for monitoring an abnormal behavior of a plurality of IoT devices comprising a processor, a network interface, a memory and a computer program loaded into the memory and executed by the processor, wherein the computer program comprises, an instruction for determining abnormality of a behavior of each of the plurality of IoT devices based on traffic data representing the behavior of each of the plurality of IoT devices, an instruction for clustering the behavior of each of the plurality of IoT devices based on the traffic data and a result of the determining the abnormality and an instruction for generating data for representing a plurality of clusters formed as a result of the clustering such that a first cluster corresponding to a normal behavior cluster and a second cluster corresponding to an abnormal behavior cluster are displayed on different planes, the first cluster and the second cluster being divided based on the result of the determining the abnormality.

According to another aspect of the present disclosure, there is provided a computer-readable recording medium recording a computer program including computer program instructions executable by a processor for monitoring an abnormal behavior of a plurality of IoT devices, wherein the computer program instructions are executed by a processor of a computing device for performing operations comprising, determining abnormality of a behavior of each of the plurality of IoT devices based on traffic data representing the behavior of each of the plurality of IoT devices, clustering the behavior of each of the plurality of IoT devices based on the traffic data and a result of the determining the abnormality and generating data for representing a plurality of clusters formed as a result of the clustering such that a first cluster corresponding to a normal behavior cluster and a second cluster corresponding to an abnormal behavior cluster are displayed on different planes, the first cluster and the second cluster being divided based on the result of the determining the abnormality.

### BRIEF DESCRIPTION OF THE DRAWINGS

FIG. 1 is a diagram for describing a system for monitoring an abnormal behavior of an IoT device according to an embodiment of the present disclosure.

FIG. 2 is a diagram for describing a method for monitoring an abnormal behavior of an IoT device according to another embodiment of the present disclosure.

FIG. 3 is a diagram for describing in more detail some operations of the method of monitoring an abnormal behavior of an IoT device described with reference to FIG. 2.

FIG. 4 is a diagram for describing in more detail traffic data that may be referred to in some embodiments of the present disclosure.

FIGS. 5 and 6 are diagrams for describing in more detail a result of determining whether a behavior of an IoT device is abnormal, as described with reference to FIG. 2.

FIG. 7 is a diagram for describing in more detail the criteria of clustering described with reference to FIG. 2.

FIG. 8 is a diagram for describing an example of a display screen for a plurality of clusters described with reference to FIG. 2.

FIGS. 9 to 11 are diagrams for describing in more detail change in a display screen for a plurality of clusters described with reference to FIG. 8.

FIG. 12 is a diagram for describing another example of a display screen for a plurality of clusters described with reference to FIG. 2.

FIG. 13 is a diagram illustrating an apparatus for monitoring an abnormal behavior of an IoT device according to another embodiment of the present disclosure.

FIG. 14 is a diagram for describing a hardware configuration of an apparatus for monitoring an abnormal behavior of an IoT device according to some embodiments of the present disclosure.

### DETAILED DESCRIPTION

Hereinafter, embodiments of the present disclosure will be described with reference to the attached drawings. Advantages and features of the present disclosure and methods of accomplishing the same may be understood more readily by reference to the following detailed description of embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will be defined by the appended claims.

In adding reference numerals to the components of each drawing, it should be noted that the same reference numerals are assigned to the same components as much as possible even though they are shown in different drawings. In addition, in describing the present disclosure, based on it being determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing embodiments and is not intended to be limiting of the present disclosure. In this specification, the singular also includes the plural unless specifically stated otherwise in the phrase.

In addition, in describing the component of this present disclosure, terms, such as first, second, A, B, (a), (b), can be used. These terms are for distinguishing the components from other components, and the nature or order of the components is not limited by the terms. Based on a component being described as being “connected,” “coupled” or “contacted” to another component, that component may be directly connected to or contacted with that other component, but it should be understood that another component also may be “connected,” “coupled” or “contacted” between each component.

Hereinafter, some embodiments of the present disclosure will be described in detail with reference to the accompanying drawings.

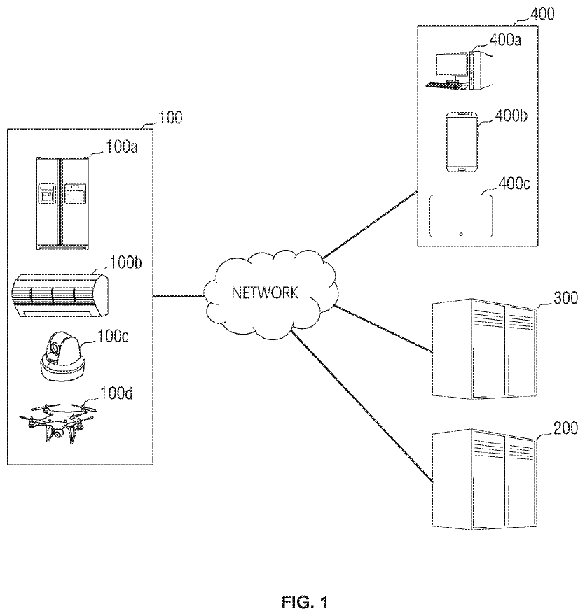

FIG. 1 is a diagram for describing a system for monitoring an abnormal behavior of an IoT device according to an embodiment of the present disclosure. Referring to FIG. 1, the system for monitoring an abnormal behavior of an IoT device may include an IoT device 100, an IoT device abnormal behavior determination apparatus 200, an IoT device abnormal behavior monitoring apparatus 300 and a user terminal 400. Each of the components of the system for monitoring an abnormal behavior of the IoT device disclosed in FIG. 1 may represent functional elements that are functionally divided, and any one or more components may be integrated and implemented with each other in an actual physical environment. Hereinafter, components of the system for monitoring an abnormal behavior of an IoT device will be described in more detail.

The IoT device 100 may include, for example, a refrigerator 100a, an air conditioner 100b, a robot cleaner 100c, and a drone 100d. However, in this embodiment, it should be noted that the IoT device 100 that can be connected to the network is not limited to the devices shown in FIG. 1, and all devices that can access the network using a communication device are included in the IoT device 100.

Next, the IoT device abnormal behavior determination apparatus 200 may collect traffic data transmitted/received accompanying various behaviors performed on the network by the plurality of IoT devices 100 connected to the network, and based on this, determine whether the behavior is abnormal for the behavior of each of the plurality of IoT devices 100.

Further, the IoT device abnormal behavior determination apparatus 200 may transmit the determination result to the IoT device abnormal behavior monitoring apparatus 300. However, it should be noted that unlike the one shown in FIG. 1, the IoT device abnormal behavior determination apparatus 200 may be implemented to be included in the IoT device abnormal behavior monitoring apparatus 300.

Next, the IoT device abnormal behavior monitoring apparatus 300 may receive traffic data transmitted/received accompanying various behaviors performed on the network by the plurality of IoT devices 100 connected to the network. Further, a result of determining whether the behavior is abnormal may be received from the IoT device abnormal behavior determination apparatus 200.

Further, the IoT device abnormal behavior monitoring apparatus 300 may cluster the behavior of each of the plurality of IoT devices 100 based on data received from the plurality of IoT devices 100 and the IoT device abnormal behavior determination apparatus 200.

Further, the IoT device abnormal behavior monitoring apparatus 300 may generate display data for a plurality of clusters formed as a result of clustering so that a normal behavior cluster and an abnormal behavior cluster divided based on the result of determining whether the behavior is abnormal received from the IoT device abnormal behavior determination apparatus 200 are displayed on different planes.

Further, the IoT device abnormal behavior monitoring apparatus 300 may transmit the generated display data to the user terminal 400.

Next, the user terminal 400 may receive display data from the IoT device abnormal behavior monitoring apparatus 300. Further, the user terminal 400 may display the received display data on the display screen.

The user terminal 400 may have a web browser or a dedicated application installed to display the display data. The user terminal 400 that may be referred to in some embodiments of the present disclosure may be any device as long as it is a device capable of outputting display data transmitted from the IoT device abnormal behavior monitoring apparatus 300. For example, the user terminal 400 that can be referred to in some embodiments of the present disclosure may be any one of a desktop 400a, a workstation, a server, a laptop, a tablet 400c, a smart phone 400b or a phablet, but is not limited thereto, and may be a device in the form of a portable multimedia player (PMP), a personal digital assistant (PDA), or an E-book reader or the like.

The user terminal 400 shown in FIG. 1 outputs display data received from the IoT device abnormal behavior monitoring apparatus 300, but the present disclosure is not limited thereto. For example, it should be noted that the user terminal 400 may receive traffic data from a plurality of IoT devices 100 connected to the network, and perform by itself the operations performed by the IoT device abnormal behavior detection apparatus 200 and the IoT device abnormal behavior monitoring apparatus 300.

Although omitted in FIG. 1 described above, it is obvious to those skilled in the art that conventional devices such as a router, which allows multiple IoT devices 100 to access the network using a single IP assigned by an ISP (Internet Service Provider), and a firewall, which monitors and selectively blocks packets, can be included in the IoT device abnormal behavior monitoring system according to the present embodiment, and a detailed description thereof will be omitted.

In the above, the system for monitoring an abnormal behavior of an IoT device according to an embodiment of the present disclosure has been described with reference to FIG. 1. More operations performed by the IoT device abnormal behavior monitoring apparatus 300 illustrated in FIG. 1 will be further specified through later description of the specification.

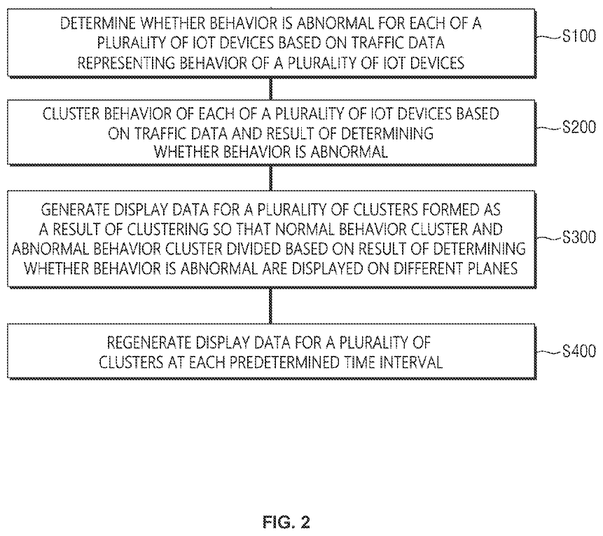

Hereinafter, a method for monitoring an abnormal behavior of an IoT device according to another embodiment of the present disclosure will be described in detail with reference to FIGS. 2 to 12. The method for monitoring an abnormal behavior of an IoT device according to the present embodiment may be performed by a computing device. For example, the method for monitoring an abnormal behavior of the IoT device according to the present embodiment may be performed by the IoT device abnormal behavior monitoring apparatus 300 illustrated in FIG. 1. Further, the method according to the present embodiment may be performed by being divided by the first computing device and the second computing device. Hereinafter, in performing each operation of the method according to the present embodiment, based on the description of the subject being omitted, the subject may be interpreted as being the computing device.

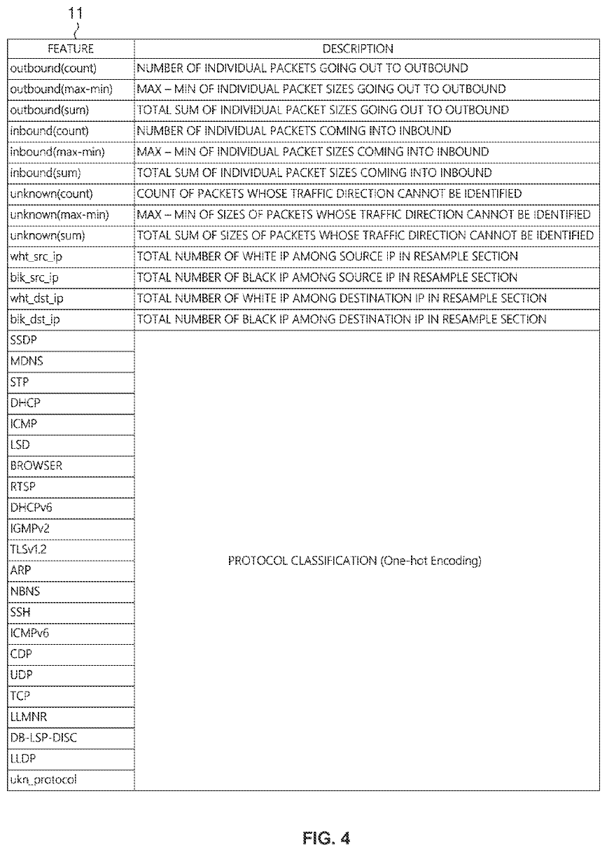

Referring to FIG. 2, in step S100, it may be determined whether the behavior is abnormal for a behavior of each of a plurality of IoT devices based on traffic data representing a behavior of a plurality of IoT devices. Here, the behavior of IoT devices may refer to an operation performed by IoT devices connected to the network. For example, it may include a connection to a network, a file transfer, and a data request. Further, the traffic data may include packets transmitted and received by the IoT device. For a more detailed description related to this, it will be described with reference to FIG. 4.

Referring to FIG. 4, it can be seen that traffic data 11 that can be used to determine whether the behavior of the IoT device is abnormal is shown. For example, in the traffic data 11, the number of individual packets going out to outbound, the difference between the maximum and the minimum of individual packet sizes going out to outbound, the total sum of individual packet sizes going out to outbound, the number of individual packets coming into inbound, the difference between the maximum and the minimum of individual packet sizes coming into inbound and the total sum of individual packet sizes coming into inbound, etc. may be included. Examples of other types of information that may be included in the traffic data 11 may be understood with reference to FIG. 4. It will be described again with reference to FIG. 2.

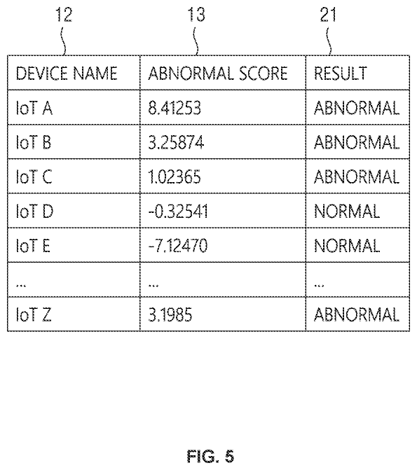

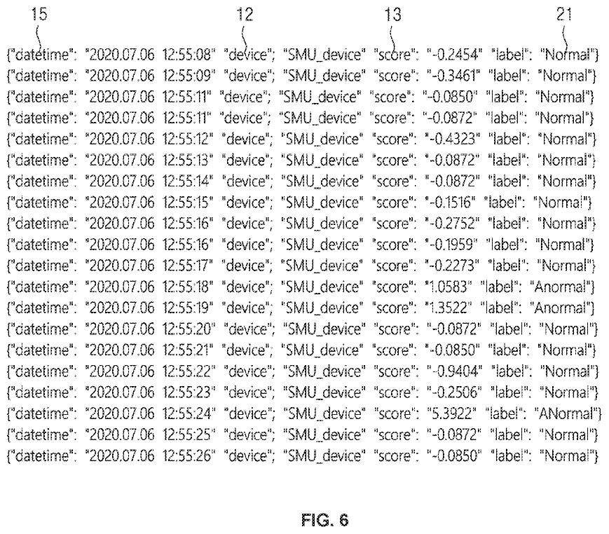

In some embodiments related to step S100, a score representing whether the behavior is abnormal for the behavior of each of a plurality of IoT devices may be generated. This score may be a score determined by a signature-based detection technique. Further, this score may be a score output by inputting traffic data to an artificial neural model, to which artificial intelligence technology is applied. That is, all known techniques capable of determining whether the behavior is abnormal for each behavior of individual IoT devices connected to the network can be applied to the present embodiment. Hereinafter, a result of determining whether the behavior of IoT device is abnormal based on a score will be described in more detail with reference to FIGS. 5 and 6.

Referring to FIG. 5, it can be seen that a score 13 representing whether the behavior is abnormal for each IoT device name 12 is shown. At this time, based on the score 13, it can be seen that the result of determining whether the behavior is abnormal 21 is shown. Further, referring to FIG. 6, for each behavior of an IoT device whose IoT device name 12 is “SMU_device,” an exemplary appearance, in which a character string representing the time of each behavior 15, a score 13 representing abnormality, and the result 21 of determining whether the behavior is abnormal is recorded, is shown.

The score 13 shown in FIGS. 5 and 6 may be output by inputting traffic data to an artificial neural model. For example, the encoder part of the auto encoder learned from general-purpose traffic data is adopted, and the traffic data is input to the model, in which the auto encoder adapted by applying SVDD (Support Vector Data Description) function as a loss function and learned from normal traffic data, and then, the score 13 is output. The score 13 may determine an abnormal behavior of the IoT device based on whether it exceeds zero. For example, based on it exceeding 0, it can be determined as an abnormal behavior, and based on it being less than 0, it can be determined as a normal behavior. It will be described again with reference to FIG. 2.

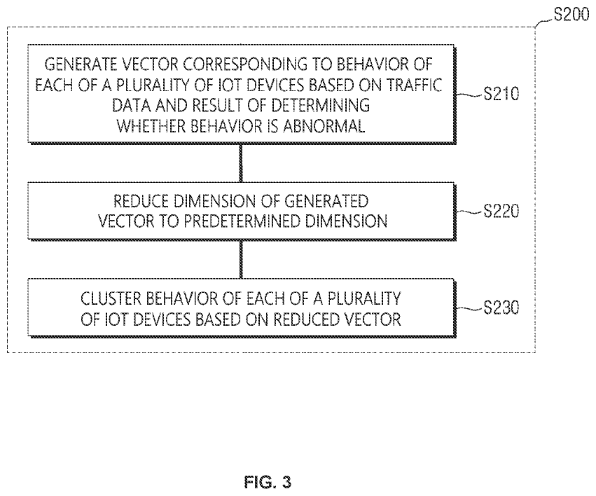

Next, in step S200, the behavior of each of the plurality of IoT devices may be clustered based on the traffic data and the result of determining whether the behavior is abnormal. For a more detailed description related to this, it will be described with reference to FIG. 3.

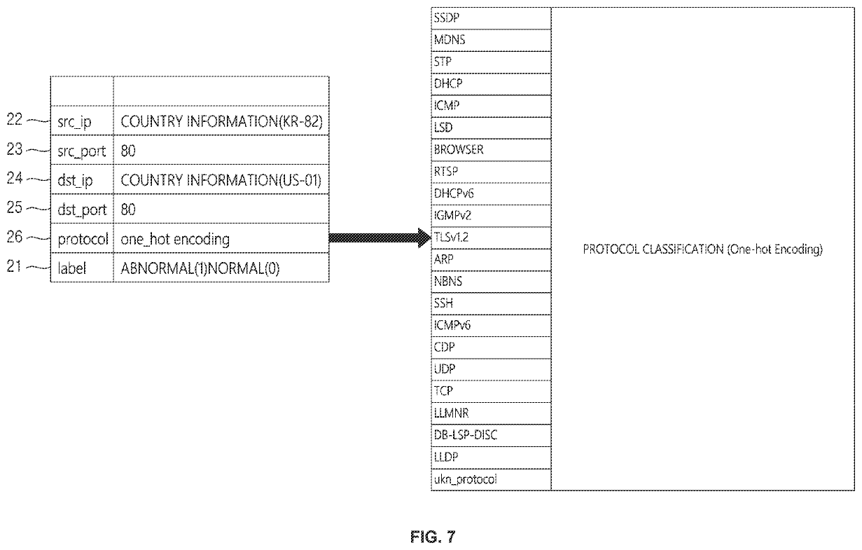

Referring to FIG. 3, in step S210, a vector corresponding to the behavior of each of a plurality of IoT devices may be generated based on the traffic data and the result of determining whether the behavior is abnormal. For a detailed description of traffic data that can be referenced in this step, it will be described with reference to FIG. 7. Referring to FIG. 7, a source IP 22, a source port 23, a destination IP 24, a destination port 25, and a protocol 26 may be included in the traffic data. It will be described again with reference to FIG. 3.

In some embodiments related to step S210, some information may be extracted from traffic data in order to generate a vector corresponding to the behavior of each of a plurality of IoT devices.

For example, country information related to the source or destination of traffic may be extracted from the traffic data. In this case, the country information may mean a country code determined for data processing and communication purposes. For another example, port information related to a source or destination of traffic may be extracted from the traffic data. In this case, based on the type of the port being well-known ports (e.g., 0-1023) designated by IANA (International Assigned Numbers Authority), the port number of the port may be determined as the port information. Based on the type of the port being a registered port (1024-49151) or a dynamic port (49152-65535), a predetermined character string (e.g., “etc”) may be determined as the port information. As another example, protocol information may be extracted from traffic data. Such protocol information may be determined such that a character string predetermined by one-hot encoding corresponds to the protocol.

Next, in step S220, the dimension of the generated vector may be reduced to a predetermined dimension. According to the example described above with reference to FIG. 7, a six-dimensional vector is generated, and such a high-dimensional vector may be the criteria for clustering without reduction in dimensions. However, in order for a user to intuitively monitor a plurality of clusters formed as a result of clustering, they may be converted from 2D to 3D vectors.

In some embodiments related to step S220, the dimension of the vector may be reduced by using PCA (Principal Components Analysis) in order to reduce the dimension of the generated vector to a predetermined dimension. PCA may be one of the dimensional reduction methods for reducing high-dimensional data to low-dimensional data, and details related thereto are obvious to those skilled in the art, and detailed descriptions thereof will be omitted. It should be noted that in addition to the illustrated PCA, all techniques capable of reducing a high-dimensional vector to a low-dimensional vector can be applied to the present disclosure.

Next, in step S230, the behavior of each of the plurality of IoT devices may be clustered based on the reduced vector. In some embodiments related to step S230, in order to cluster the behavior of each of a plurality of IoT devices, DBSCAN (Density-Based Spatial Clustering of Applications with Noise) may be used. DBSCAN may be a density-based clustering method, which is a method of clustering based on a reference radius (Epsilon) and the minimum number of vectors in a cluster. Since detailed information related thereto is obvious to those skilled in the art, a more detailed description will be omitted. Further, it should be noted that in addition to the exemplified DBSCAN, all techniques capable of clustering a plurality of reduced vectors can be applied to the present disclosure. It will be described again with reference to FIG. 2.

Next, in step S300, display data for a plurality of clusters formed as a result of clustering may be generated so that the normal behavior cluster and the abnormal behavior cluster divided based on a result of determining whether the behavior is abnormal are displayed on different planes.

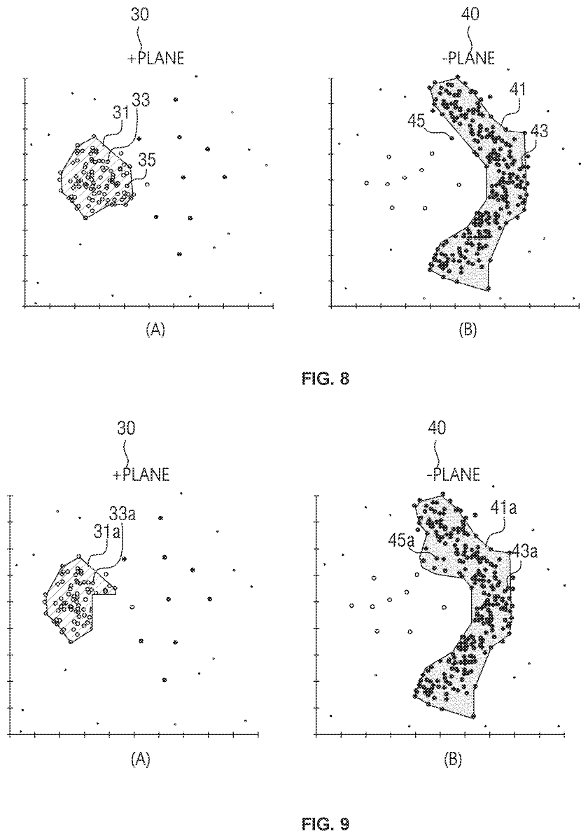

In some embodiments related to step S300, a dimension-reduced vector corresponding to the behavior of each of a plurality of IoT devices may be expressed in a 2D space, and a cluster formed as a result of clustering may also be expressed in the 2D space. For example, a 6D vector according to the example described with reference to FIG. 7 may be reduced to 2D, and the reduced vector may be expressed in a 2D space. For another example, among the vector items according to the example described with reference to FIG. 7 above, a five-dimensional vector excluding the item of the determination result on whether the behavior is abnormal may be reduced to two dimensions, and the reduced vector may be expressed in a two-dimensional space. In this case, the normal behavior cluster and the abnormal behavior cluster divided based on the result of determining whether the behavior is abnormal may be displayed on different planes. In order to describe an example related thereto, FIG. 8 will be referenced.

Referring to FIG. 8, a first cluster 31 may be expressed on the (+) plane 30, and a second cluster 41 may be expressed on the (−) plane 40. Each of the clusters may display the result of clustering the dimension-reduced vectors corresponding to the behavior of each of the plurality of IoT devices. At this time, the normal behavior cluster and the abnormal behavior cluster may be divided based on the result of determining whether the behavior is abnormal are displayed on different planes.

For example, a result of clustering a dimension-reduced vector corresponding to a normal behavior among the behaviors of each of a plurality of IoT devices may be expressed on the (+) plane 30, and a result of clustering a dimension-reduced vector corresponding to an abnormal behavior among the behaviors of each a plurality of IoT devices may be expressed on the (−) plane 40. In this case, the first cluster 31 may be a normal behavior cluster and the second cluster 41 may be an abnormal behavior cluster.

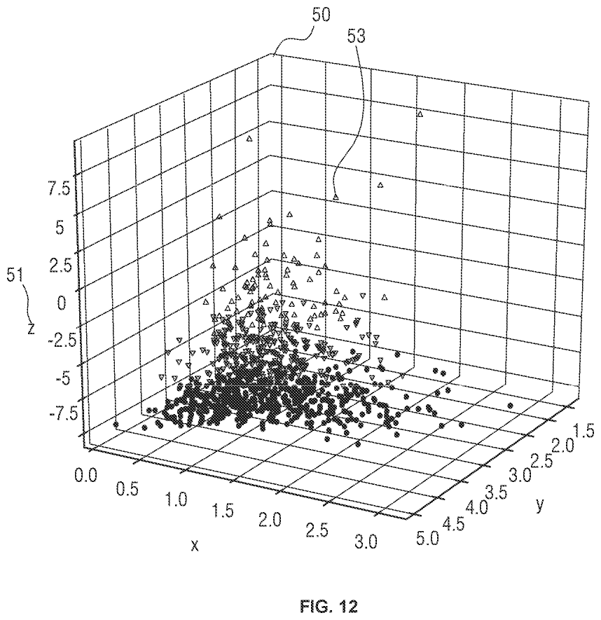

In some other embodiments related to step S300, a dimension-reduced vector corresponding to the behavior of each of the plurality of IoT devices may be expressed in a 3D space, and a cluster formed as a result of clustering may also be expressed in the 3D space. For example, a 6D vector according to the example described with reference to FIG. 7 may be reduced to 3D, and the reduced vector may be expressed in a 3D space. For another example, among the vector items according to the example described with reference to FIG. 7 above, a five-dimensional vector excluding the item of the determination result on whether the behavior is abnormal is reduced to two dimensions, and one dimension according to the result of determining whether the behavior is abnormal may be added and expressed in a 3D space. At this time, the result of determining whether the behavior is abnormal may be expressed on any one axis in the 3D space by the score. In order to describe an example related to this, FIG. 12 will be referenced.

Referring to FIG. 12, an indicator 53 corresponding to a behavior of each of a plurality of IoT devices may be displayed on the 3D space 50. In this case, the value of the z-axis 51 of the 3D space 50 may correspond to a result of determining whether the behavior is abnormal. For example, it may be displayed so that the normal behavior cluster is expressed in a space where the value of the z-axis 51 is positive in the 3D space 50, and the abnormal behavior cluster is expressed in a space where the value of the z-axis 51 is negative in the 3D space 50.

According to step S300 described above, the abnormal behavior cluster and the normal behavior cluster may be visually divided and displayed so that the user can intuitively monitor the behavior of a plurality of IoT devices connected to the network.

Hereinafter, embodiments related to an indicator and a cluster that help a user to more intuitively monitor the behavior of a plurality of IoT devices will be described.

In some other embodiments related to step S300, an indicator representing each behavior of the IoT device included in the cluster may be displayed together. Referring to FIG. 8, in addition to the indicators included in the first cluster 31 and the second cluster 41, indicators not included in the clusters may be identified. According to the present embodiment, more intuitive information can be provided to a user by displaying indicators representing each behavior of an IoT device together with a cluster.

In still another embodiment related to step S300, an indicator representing the behavior of the IoT device may be highlighted based on the holding time of each behavior of the IoT device included in the cluster. For example, the indicator may be highlighted based on the holding time of the behavior of the IoT device included in the abnormal behavior cluster. For another example, the indicator may be highlighted based on the holding time of the behavior of the IoT device included in the normal behavior cluster. In this case, all known techniques for highlighting the displayed object, such as an increase in the size of the indicator, an increase in the saturation of the indicator color, and an increase in the thickness of an outline of the indicator, may be applied to the highlighting of the indicator. In another embodiment, an indicator representing the behavior of an IoT device initially included in the cluster may be highlighted. For example, an indicator initially included in the abnormal behavior cluster may be highlighted. For another example, an indicator initially included in the normal behavior cluster may be highlighted. In this case, a description related to the highlighting of the indicator may be understood by referring to the contents described above.

In some other embodiments related to step S300, the cluster may be highlighted based on the number of behaviors of the IoT device initially included in the cluster per unit time. That is, the cluster can be highlighted based on the amount of change in the behavior included in the cluster. For example, based on the amount of change of the indicator included in the abnormal behavior cluster being greater than or equal to the reference value, the cluster may be highlighted. For another example, based on the amount of change of the indicator included in the normal behavior cluster being greater than or equal to the reference value, the cluster may be highlighted. In this case, a description related to highlighting of the cluster may be understood by referring to the description related to highlighting of the indicator described above. In another embodiment, based on there being behavior of the IoT device initially included in the abnormal behavior cluster, the abnormal behavior cluster may be highlighted. In this case, a description related to highlighting of the cluster may be understood by referring to the above description.

According to the exemplary embodiments related to the indicator and the cluster described above, by highlighting the indicator based on the holding time included in the cluster, the behavior of an IoT device may be focused and monitored. Further, based on there being an indicator initially included in the cluster, by highlighting the indicator or the cluster, the behavior of the IoT device that is initially generated may be focused and monitored. Furthermore, by highlighting the cluster based on the amount of change in the indicator included in the cluster, the increase or decrease of behaviors of IoT devices having similar properties included in the cluster may be intuitively monitored. For example, vulnerability exploitation attacks on IoT device groups or product groups included in abnormal behavior clusters may be intuitively monitored.

According to step S300 described above, by monitoring the behaviors of a plurality of IoT devices, an appropriate response corresponding to the abnormal behavior may be performed. For example, it is possible to isolate networks for device groups or product groups or power down. Further, it is also possible to request patch updates for device groups or product groups.

Next, in step S400, display data for a plurality of clusters may be regenerated at each predetermined time interval. For example, traffic data representing the behavior of a plurality of IoT devices connected to the network is collected at each predetermined time interval, and based on this, the operations of steps S100 to S300 described above may be performed, thereby regenerating display data for a plurality of clusters.

In some embodiments related to step S400, operations of steps S100 to S300 may be performed based on traffic data collected at each predetermined time interval.

In some other embodiments, operations of steps S100 to S300 may be performed in consideration of not only traffic data collected at the corresponding time interval but also traffic data collected in the past time interval. Here, based on the traffic data collected in the past time interval being greater than or equal to the reference time interval from the corresponding time interval, it may be excluded from the operations of steps S100 to S300. According to the present embodiment, a process of changing display data for a plurality of clusters may be gradually expressed.

Hereinafter, changes in a display screen for a plurality of clusters according to changes in traffic data will be described in detail with reference to FIGS. 9 to 11. For convenience of description, the following will be described according to an embodiment of regenerating display data based on traffic data collected at each predetermined time interval. However, it should be noted that the present disclosure is not limited thereto.

Referring to FIG. 8, a first cluster 31 on the (+) plane 30 and a second cluster 41 on the (−) plane 40 can be seen. In this case, the first cluster 31 may include a first indicator 33 and a second indicator 35, and the second cluster 41 may include a third indicator 43. The fourth indicator 45 on the (−) plane 40 may not be include in any cluster. In this case, it is assumed that the drawing shown in FIG. 8 is a screen displayed based on the traffic data collected in the past time interval, the drawings shown in FIGS. 9 to 11 are screens displayed based on the traffic data collected at the corresponding time interval.

Referring to FIG. 9, unlike FIG. 8, the size of the changed first cluster 33a has been reduced, and the changed first indicator 33a is still included in the changed first cluster 33a, while the second indicator is excluded from the (+) plane 30. Further, the changed second cluster 41a has an enlarged cluster size, and the changed fourth indicator 45a is included in the changed second cluster 41a. As described with reference to FIG. 9, positions of expressed indicators may be changed according to changes in collected traffic data, and a size of a cluster is also changed according to changes in positions of indicators. For example, based on normal behavior indicators being expressed on the (+) plane 30 and abnormal behavior indicators are expressed on the (−) plane 40, the user can determine that the abnormal behavior of the IoT device is increased from the traffic data collected at the corresponding time interval.

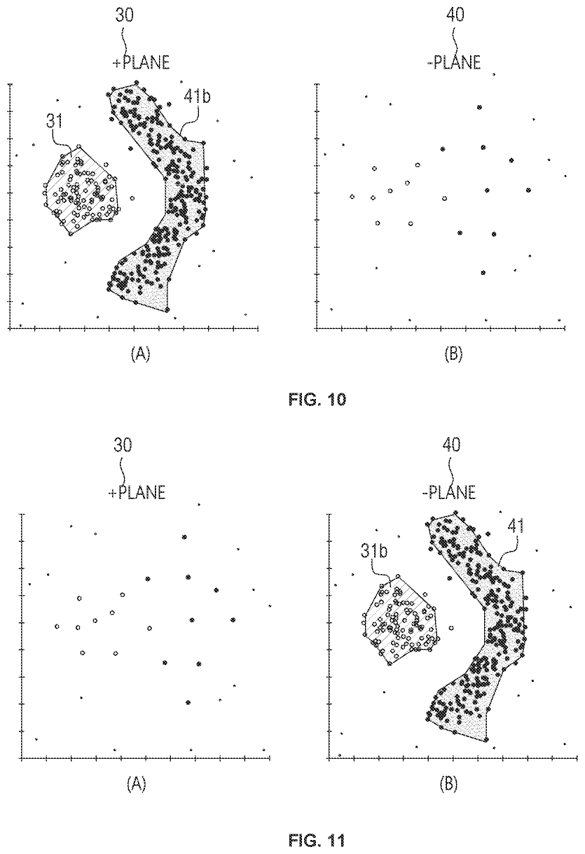

Referring to FIG. 10, unlike FIG. 8, it can be seen that another changed second cluster 41b is shown on the (+) plane 30. For example, based on normal behavior indicators being expressed on the (+) plane 30 and abnormal behavior indicators are expressed on the (−) plane 40, the user can determine that the behaviors of IoT devices determined as abnormal behaviors in the past time interval has changed into the normal behavior at the corresponding time interval. On the other hand, referring to FIG. 11, unlike FIG. 8, it can be seen that another changed first cluster 31b is shown on the (−) plane 40. For example, based on normal behavior indicators being expressed on the (+) plane 30 and abnormal behavior indicators are expressed on the (−) plane 40, the user can determine that the behaviors of IoT devices determined as normal behaviors in the past time interval has changed into the abnormal behavior at the corresponding time interval.

So far, a method for monitoring abnormal behavior of an IoT device according to another embodiment of the present disclosure and its application field have been described with reference to FIGS. 2 to 12. According to this embodiment, abnormal behavior of an IoT device connected to a network can be intuitively monitored. Further, by re-clustering the behavior of each of the plurality of IoT devices based on the change in traffic data and regenerating the display data based on the cluster formed as a result of the clustering, the behavior trend of each IoT device connected to the network can be also monitored.

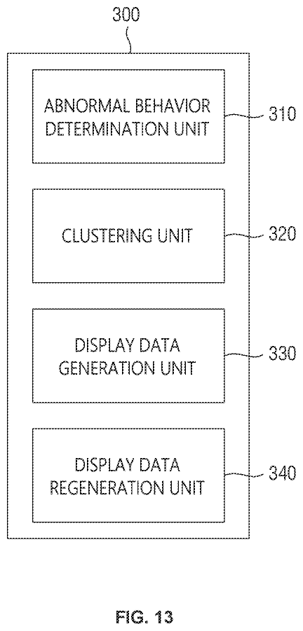

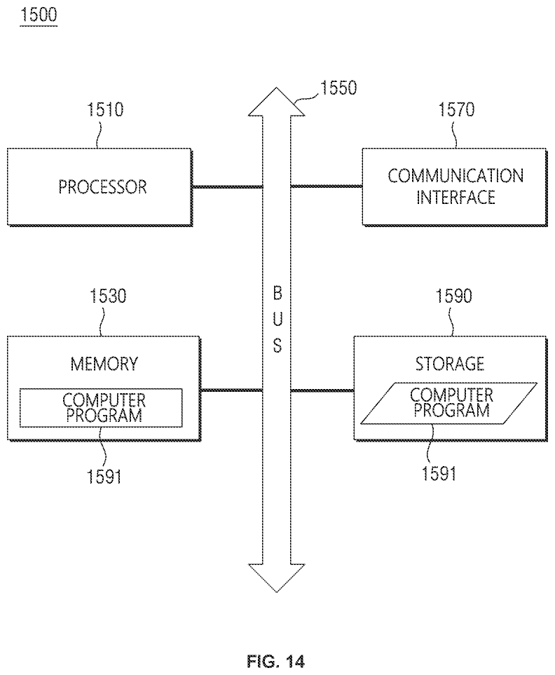

Hereinafter, an apparatus for monitoring abnormal behavior of an IoT device according to another embodiment of the present disclosure will be described with reference to FIGS. 13 to 14.

Referring to FIG. 13, the IoT device abnormal behavior monitoring apparatus 300 may include an abnormal behavior determination unit 310, a clustering unit 320, a display data generation unit 330 and a display data regeneration unit 340. Each of the components of the IoT device abnormal behavior monitoring apparatus 300 disclosed in FIG. 13 represents functional elements that are functionally divided, and any one or more components may be integrated and implemented with each other in an actual physical environment. Hereinafter, the components of the IoT device abnormal behavior monitoring apparatus 300 will be described in more detail.

The abnormal behavior determination unit 310 may determine whether the behavior is abnormal for the behavior of each of the plurality of IoT devices based on the traffic data representing behaviors of the plurality of IoT devices. More operations performed by the abnormal behavior determination unit 310 may be embodied with reference to the description of step S100 described with reference to FIG. 2.

The clustering unit 320 may cluster the behavior of each of the plurality of IoT devices based on the traffic data and the result of determining whether the behavior is abnormal. More operations performed by the clustering unit 320 may be embodied with reference to the description of step S200 described with reference to FIG. 2.

The display data generation unit 330 may generate display data for a plurality of clusters formed as a result of clustering so that the normal behavior cluster and the abnormal behavior cluster divided based on the result of determining whether the behavior is abnormal are displayed on different planes. More operations performed by the display data generation unit 330 may be embodied with reference to the description of step S300 described with reference to FIG. 2.

The display data regeneration unit 340 may regenerate display data for a plurality of clusters at each predetermined time interval. More operations performed by the display data regeneration unit 340 may be embodied with reference to the description of step S400 described with reference to FIG. 2.

Hereinafter, an exemplary computing device 1500 that can implement an apparatus and a system, according to various embodiments of the present disclosure will be described with reference to FIG. 14.

FIG. 14 is an example hardware diagram illustrating a computing device 1500.

As shown in FIG. 14, the computing device 1500 may include one or more processors 1510, a bus 1550, a communication interface 1570, a memory 1530, which loads a computer program 1591 executed by the processors 1510, and a storage 1590 for storing the computer program 1591. However, FIG. 14 illustrates the components related to the embodiment of the present disclosure. It will be appreciated by those skilled in the art that the present disclosure may further include other general purpose components in addition to the components shown in FIG. 14.

The processor 1510 may control overall operations of each component of the computing device 1500. The processor 1510 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 1510 may perform calculations on at least one application or program for executing a method/operation according to various embodiments of the present disclosure. The computing device 1500 may have one or more processors.

The memory 1530 may store various data, instructions and/or information. The memory 1530 may load one or more programs 1591 from the storage 1590 to execute methods/operations according to various embodiments of the present disclosure. For example, based on the computer program 1591 being loaded into the memory 1530, the logic as shown in FIG. 2 may be implemented on the memory 1530. An example of the memory 1530 may be a RAM, but is not limited thereto.

The bus 1550 may provide communication between components of the computing device 1500. The bus 1550 may be implemented as various types of bus such as an address bus, a data bus and a control bus.

The communication interface 1570 may support wired and wireless internet communication of the computing device 1500. The communication interface 1570 may support various communication methods other than internet communication. To this end, the communication interface 1570 may be configured to comprise a communication module based on hardware and/or software well known in the art of the present disclosure.

The storage 1590 can non-temporarily store one or more computer programs 1591. The storage 1590 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 1591 may include one or more instructions, on which the methods/operations according to various embodiments of the present disclosure are implemented. Based on the computer program 1591 being loaded on the memory 1530, the processor 1510 may perform the methods/operations in accordance with various embodiments of the present disclosure by executing the one or more instructions.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although the operations are shown in an order in the drawings, those skilled in the art will appreciate that many variations and modifications can be made to the embodiments without substantially departing from the principles of the present disclosure. The disclosed embodiments of the present disclosure may be used in a generic and descriptive sense and not for purposes of limitation. The scope of protection of the present disclosure should be interpreted by the following claims, and all technical ideas within the scope equivalent thereto should be construed as being included in the scope of the technical idea defined by the present disclosure.

What is claimed is:

1. A method performed by a computing device for monitoring an abnormal behavior of a plurality of IoT devices comprising:
determining abnormality of a behavior of each of the plurality of IoT devices based on traffic data representing the behavior of each of the plurality of IoT devices;
clustering the behavior of each of the plurality of IoT devices based on the traffic data and a result of the determining the abnormality; and
generating data for representing a plurality of clusters formed as a result of the clustering such that a first cluster corresponding to a normal behavior cluster and a second cluster corresponding to an abnormal behavior cluster are displayed on different planes, the first cluster and the second cluster being divided based on the result of the determining the abnormality.

2. The method of claim 1,
wherein the clustering comprises,
generating a vector corresponding to the behavior of each of the plurality of IoT devices based on the traffic data and the result of the determining the abnormality;
reducing a dimension of the vector to a predetermined dimension; and
clustering the behavior of each of the plurality of IoT devices based on a dimension-reduced vector.

3. The method of claim 2 further comprises
extracting, from the traffic data, an origination country of traffic or a destination county of the traffic.

4. The method of claim 2 further comprises
extracting, from the traffic data, port information related to traffic, the port information including an originating port or a destination port.

5. The method of claim 4,
wherein extracting the port information comprises
based on a type of the port being a well-known port type, designating a port number as the port information, and
based on the type of the port being a registered port type or a dynamic port type, designating a predetermined character string as the port information.

6. The method of claim 2 further comprises
one-hot encoding an information of a protocol associated with the traffic data.

7. The method of claim 2,
wherein reducing the dimension of the vector to the predetermined dimension comprises reducing the dimension of the vector to two dimensions using PCA (Principal Components Analysis).

8. The method of claim 2,
wherein clustering the behavior of each of the plurality of IoT devices based on the dimension-reduced vector comprises clustering the behavior of each of the plurality of IoT devices using DBSCAN (Density-Based Spatial Clustering of Applications with Noise).

9. The method of claim 2,
wherein determining the abnormality of the behavior of each of the plurality of IoT devices based on the traffic data representing the behavior of each of the plurality of IoT devices comprises
generating a score representing the abnormality of the behavior of each of the plurality of IoT devices,
wherein generating the data for representing the plurality of clusters comprises
generating the data for displaying the dimension-reduced vector corresponding to the behavior of each of the plurality of IoT devices and the score in a three-dimensional space.

10. The method of claim 9,
wherein generating the data for representing the plurality of clusters comprises
generating the data such that the first cluster is displayed in a space where a z-axis value is positive in the three-dimensional space, and the second cluster is displayed in the space where the z-axis value is negative in the three-dimensional space.

11. The method of claim 1,
wherein generating the data for representing the plurality of clusters comprises
generating an individual indicator representing the behavior of the each of the plurality of IoT devices included in a target cluster.

12. The method of claim 11,
wherein generating the individual indicator comprises
generating data for highlighting the individual indicator representing the behavior, the highlighting being based on a duration of the behavior.

13. The method of claim 11,
wherein generating the individual indicator comprises
generating display data for highlighting the individual indicator representing a behavior of an IoT device that has been newly identified as falling into the target cluster.

14. The method of claim 1,
wherein generating the data for representing the plurality of clusters comprises
generating the data for highlighting a target cluster based on the number of behaviors of IoT devices that have been newly identified as falling into the target cluster per unit time.

15. The method of claim 1,
wherein generating the data for representing the plurality of clusters comprises
in response to recognizing a behavior of a IoT device that has been newly identified as falling into the second cluster, generating the data for highlighting the second cluster.

16. The method of claim 1 further comprises
regenerating the data for representing the plurality of clusters at each predetermined time interval.

17. The method of claim 16,
wherein regenerating the data for representing the plurality of clusters comprises
gradually representing a process of changing display data for the plurality of clusters.

18. An apparatus for monitoring an abnormal behavior of a plurality of IoT devices comprising:
a processor;
a network interface;
a memory; and
a computer program loaded into the memory and executed by the processor,
wherein the computer program comprises
an instruction for determining abnormality of a behavior of each of the plurality of IoT devices based on traffic data representing the behavior of each of the plurality of IoT devices;
an instruction for clustering the behavior of each of the plurality of IoT devices based on the traffic data and a result of the determining the abnormality; and
an instruction for generating data for representing a plurality of clusters formed as a result of the clustering such that a first cluster corresponding to a normal behavior cluster and a second cluster corresponding to an abnormal behavior cluster are displayed on different planes, the first cluster and the second cluster being divided based on the result of the determining the abnormality.

19. The method of claim 18,
wherein the instruction for the clustering comprises
an instruction for generating a vector corresponding to the behavior of each of the plurality of IoT devices based on the traffic data and the result of the determining the abnormality;
an instruction for reducing a dimension of the vector to a predetermined dimension; and
an instruction for clustering the behavior of each of the plurality of IoT devices based on a dimension-reduced vector.

20. A computer-readable recording medium recording a computer program including computer program instructions executable by a processor for monitoring an abnormal behavior of a plurality of IoT devices,
wherein the computer program instructions are executed by a processor of a computing device for performing operations comprising
determining abnormality of a behavior of each of the plurality of IoT devices based on traffic data representing the behavior of each of the plurality of IoT devices;
clustering the behavior of each of the plurality of IoT devices based on the traffic data and a result of the determining the abnormality; and
generating data for representing a plurality of clusters formed as a result of the clustering such that a first cluster corresponding to a normal behavior cluster and a second cluster corresponding to an abnormal behavior cluster are displayed on different planes, the first cluster and the second cluster being divided based on the result of the determining the abnormality.
